(19) United States
(12) Patent Application Publication
(10) Pub. No.: US 2011/0063833 A1
(43) Pub. Date: Mar. 17, 2011

(54) LED LAMP WITH DOUBLE FACES ILLUMINATION

(76) Inventors: Meng Hsieh Chou, Sinjhuang City (TW); Yen Wei Pen, Sinjhuang City (TW); Ming Xian Lin, Sinjhuang City (TW); Yen Chi Wu, Sinjhuang City (TW)

(21) Appl. No.: 12/634,076

(22) Filed: Dec. 9, 2009

(30) Foreign Application Priority Data
Sep. 15, 2009 (TW) 098131084

(51) Int. Cl. F21V 1/00

(52) U.S. Cl. 362/235; 362/294

(57) ABSTRACT

A LED lamp with double faces illumination includes a heat sink, two illumination modules and two lamp shades. The heat sink has a first surface, which has a first accommodating space and a second surface, which has a second accommodating space, the first accommodating space is formed with two first guide rails relatively on both sides of first accommodating space, the second accommodating space is formed with two second guide rails relatively on both sides of second accommodating space. The two LED illumination modules are arranged at the first accommodating space and the second accommodating space individually. And the two lamp shades are mounted on the first accommodating space and the second accommodating space individually to cover the two LED illumination modules.

### BACKGROUND OF THE INVENTION

1. Field of the Invention

The present invention relates to an LED lamp with double faces illumination, and in particular to an LED lamp capable of assembling easily and decreasing the cost of the manufacture.

2. Description of the Related Art

Since light emitting diodes (LEDs) feature the high brightness, power saving and long life expectancy advantages, they have been used extensively for the illumination lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. Therefore, it is an important subject for manufacturers in the related field to design an LED lamp with good directionality and even brightness.

As is generally known in the art, use has been made of varying kinds of illumination lamps at night or indoors. Such illumination lamps are supplied with electric energy from a power source and convert the electric energy to light energy, thereby producing a beam of light for illumination. Typical examples of the illumination lamps include a glow tamp and a fluorescent lamp.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp.

Please refer to FIG. 1, an exploded view of the traditional daylight lamp includes lamp tube 10 and lamp base 20. The lamp tube 10 has a body 11 and a metal end 12, which has an electrode connection 13. The lamp base 20 has a lamp body 21, electrode base 22 and a starter 23. The electrode base 22 is arranged at the both side of the lamp body, and formed with electrode hole 24.

Please refer to FIG. 2A, a traditional LED lamp tube includes a core tube 31, a lamp shade 32, a print circuit board 33 and LED 34. Above-mention LED lamp has a single illumination face only, so as to the traditional LED lamp can not provide double faces illumination.

Please refer to FIG. 2B, it is a double faces illumination lamp 40, which has a heat sink 41 and light source 42 mounted at the two sides of the heat sink 41.

### SUMMARY OF THE INVENTION

The present invention discloses an LED lamp with double faces illumination may be resolved aforementioned questions.

An object of the present invention is to provide an LED lamp with double faces illumination capable of assembling easily to reduce the assembling cost.

An object of the present invention is to provide an LED lamp with double faces illumination capable of providing best heat dissipation.

To achieve the above-mentioned object, the present invention comprises a heat sink, two LED illumination modules and two lamp shades. The heat sink has a first surface, which has a first accommodating space and a second surface, which has a second accommodating space, the first accommodating space is formed with two first guide rails relatively on both sides of first accommodating space, the second accommodating space is formed with two second guide rails relatively on both sides of second accommodating space. The two LED illumination modules are arranged at the first accommodating space and the second accommodating space of the heat sink individually. And the two lamp shades are mounted on the first accommodating space and the second accommodating space individually to cover the two LED illumination modules.

However, the lamp shades may be assembly in the first surface and the second surface of the heat sink easily to cover the two LED illumination modules.

### BRIEF DESCRIPTION OF THE DRAWINGS

FIG. 1 is an exploded view of a traditional daylight lamp.

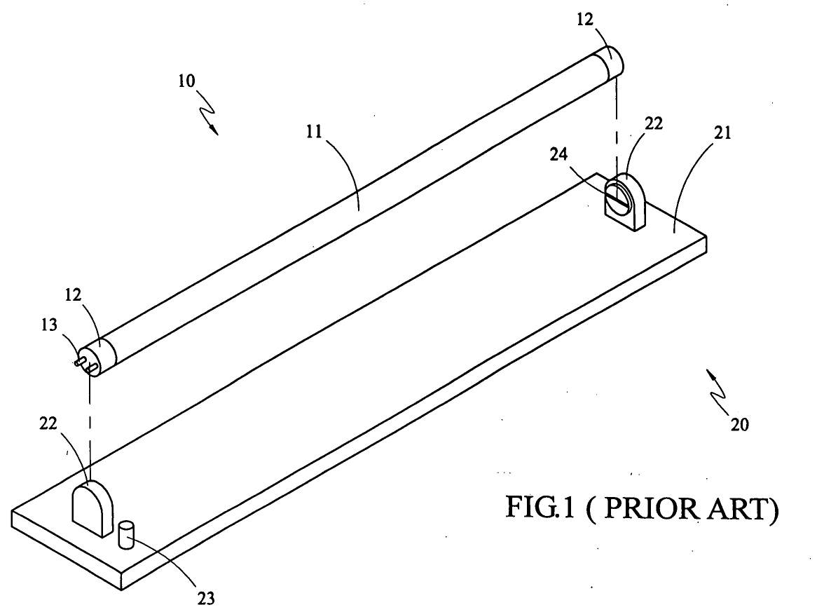

FIG. 2A is an assembly drawing of a traditional LED lamp.

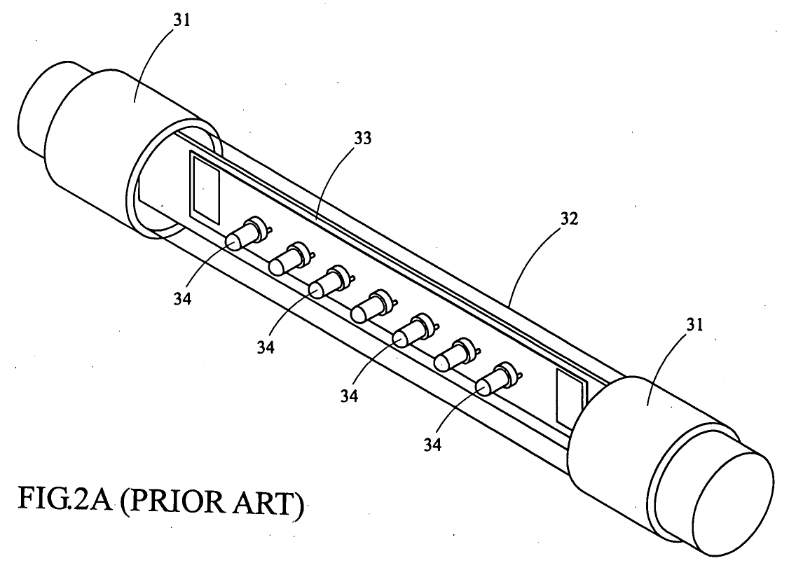

FIG. 2B is a cross-sectional view of a traditional LED lamp with double faces illumination

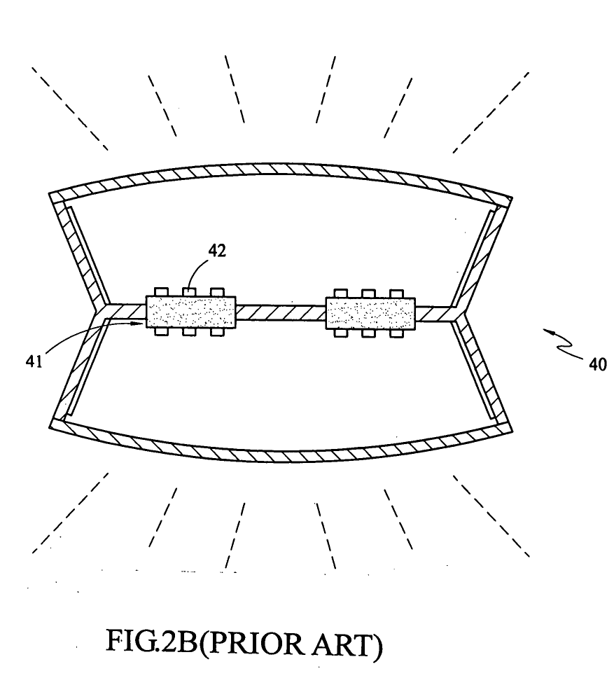

FIG. 3 is an exploded view of LED lamp with double faces illumination of the present invention

FIG. 4 is an assembly drawing of the FIG. 3.

FIG. 5 is an illustrated schematic of the FIG. 3.

FIG. 6 is a cross-sectional view of the FIG. 4.

### DETAILED DESCRIPTION OF THE INVENTION

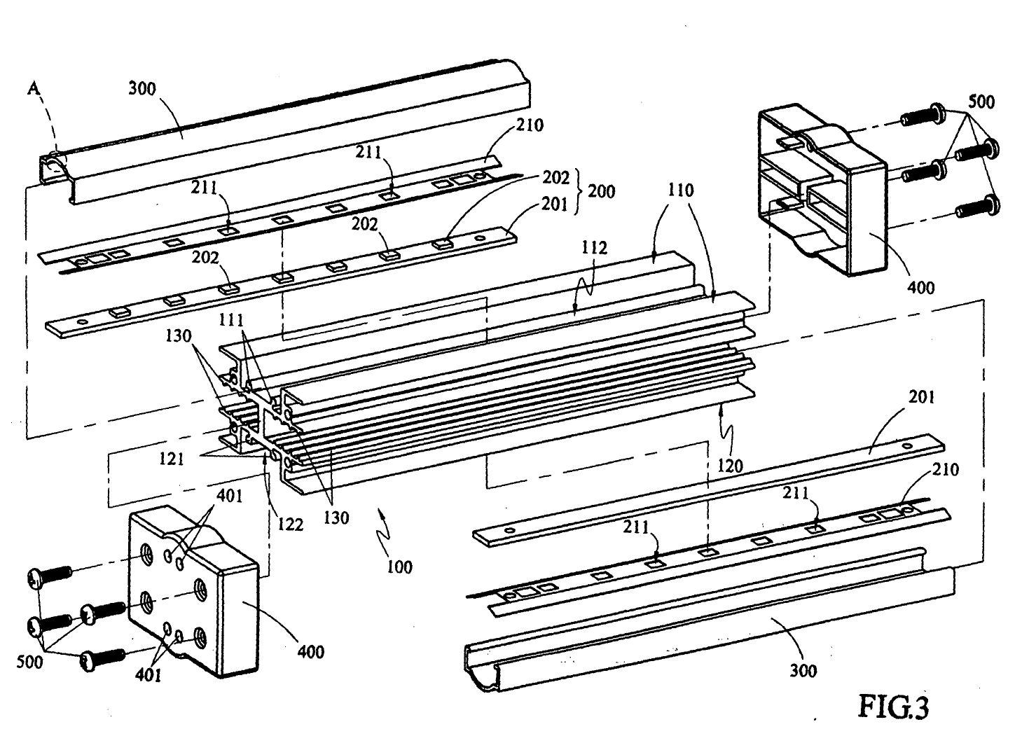

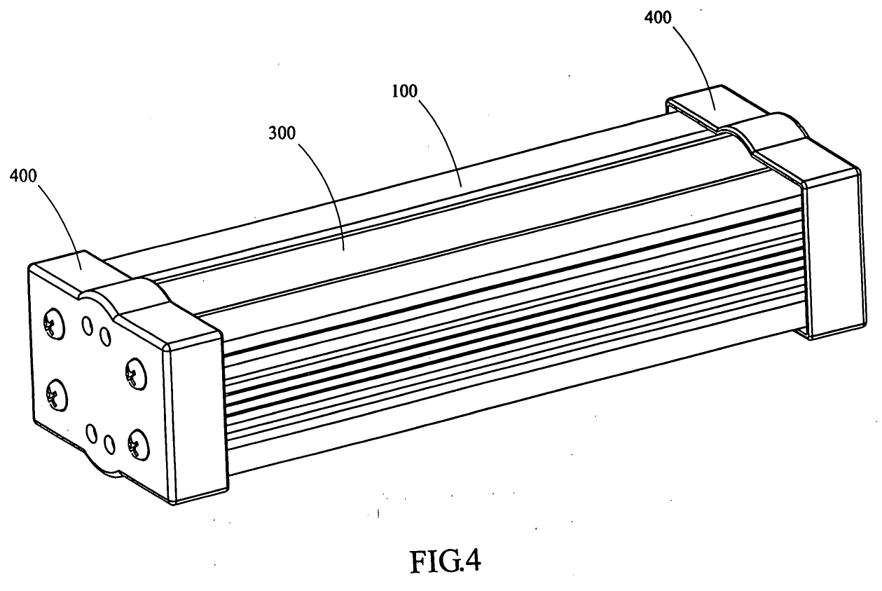

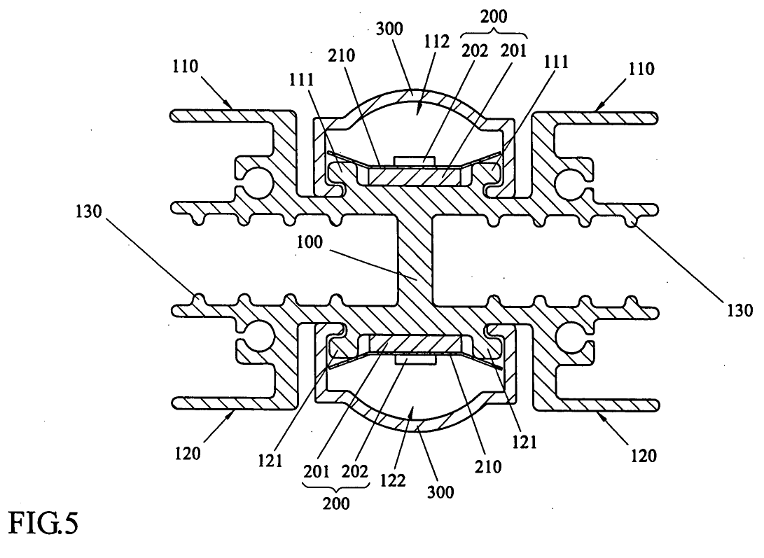

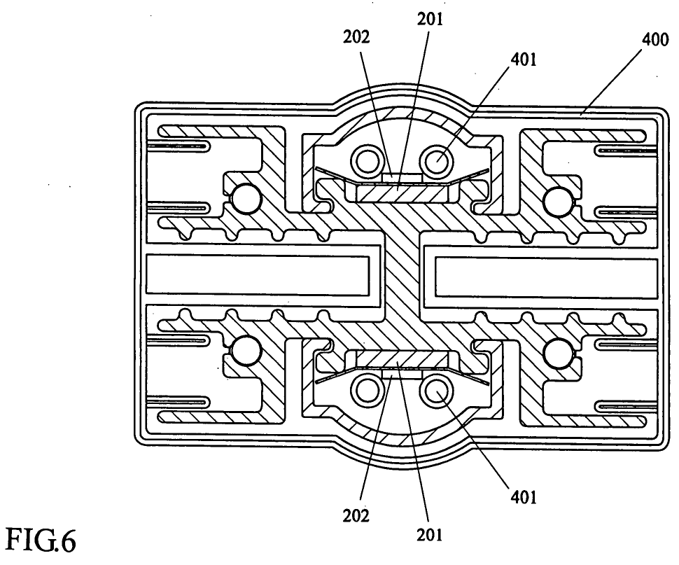

Referring to FIG. 3-FIG. 6, an LED lamp with double faces illumination of the present invention includes a heat sink 100, two LED illumination modules 200, two side covers 400, two reflecting plate 210 and two lamp shades 300.

The heat sink 100 has a first surface 110, which has a first accommodating space 112 and a second surface 120, which has a second accommodating space 122, the first accommodating space 112 is formed with two first guide rails 111 relatively on both sides of first accommodating space, the second accommodating space 122 is formed with two second guide rails 121 relatively on both sides of second accommodating space.

The two LED illumination modules 200 are arranged at the first accommodating space 112 and the second accommodating space 122 of the heat sink 100 separately. Wherein each LED illumination modules 200 include a print circuit board 201 and LEDS 202 formed on the print circuit board 201.

The reflecting plate 210 is formed with holes 211 relatively the LED 202 and mounted on the print circuit board 201, so as to each LED 202 may be exposed through the holes 211 of the reflecting plate 210.

The each side cover 400 has fixed holes 401, which are screwed at both side of the heat sink 100 by screwed elements 500 to cover the LED illumination modules 200.

The two lamp shades 300 are mounted on the first accommodating space 112 and the second corresponding space 122 of the heat sink 100 individually through the first rails 111 and the second guide rails 121 to cover the two LED illumination modules 220, so as to the lamp 300 may be covered.

While the present invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modification.

What is clamed is:

1. A LED lamp with double faces illumination comprising:
A heat sink having a first surface, which has a first accommodating space and a second surface, which has a second accommodating space, the first accommodating space formed with two first guide rails relatively on both sides of first accommodating space, the second accommodating space formed with two second guide rails relatively on both sides of second accommodating space;
Two LED illumination modules arranged at the first accommodating space and the second accommodating space of the heat sink individually; and
Two lamp shades mounted on the first accommodating space and the second accommodating space of the heat sink individually by the first guide rails and the second guide rails to cover the two LED illumination modules.

2. The LED lamp with double faces illumination according to claim 1, further comprising two side covers to cover on the both sides of the heat sink.

3. The LED lamp with double faces illumination according to claim 2, wherein the two side covers are screwed at the both sides of the heat sink.

4. The LED lamp with double faces illumination according to claim 1, wherein the LED illumination module includes a print circuit board and a plurality of LEDs formed on the print circuit board.

5. The LED lamp with double faces illumination according to claim 4, further comprising a reflecting plate formed on the print circuit board, the reflecting plate has holes relatively the LEDS, so as to the LEDS may be exposed through the holes.
